(19) United States
(12) Patent Application Publication
(10) Pub. No.: US 2020/0390244 A1
(43) Pub. Date: Dec. 17, 2020

(54) Seat Serial Number Plate

(71) Applicant: Spec Seats Technologies Inc., Taoyuan City (TW)

(72) Inventor: Mei Chuen Lin, Taoyuan City (TW)

(73) Assignee: Spec Seats Technologies Inc.

(21) Appl. No.: 16/438,172

(22) Filed: Jun. 11, 2019

(51) Int. Cl. A47C 7/62; A47C 1/124; G09F 7/20; G09F 7/16

(52) U.S. Cl. CPC A47C 7/62; A47C 1/124; G09F 2007/127; G09F 7/16; G09F 7/20

(57) ABSTRACT

A seat serial number plate is provided, including a plate and a bracket. The plate has a first surface and a second surface, the first surface is for displaying a serial number; the bracket comprises at least a connecting portion, a supporting portion and a seat engaging portion, the at least a connecting portion is disposed on the second surface of the plate, the supporting portion is disposed on the at least a connecting portion, and the seat engaging portion is disposed on the supporting portion and configured to be detachably disposed on an assembly portion of a seat. Thereby, the present invention is conveniently assembled onto the seat by the seat engaging portion to achieve fast assembly and disassembly. Furthermore, the present invention enables the participants to quickly and conveniently locate the seat by a seat serial number printed on the printed layer or a sticker on the plate.

### BACKGROUND OF THE INVENTION

### 1. Field of the Invention

The present invention relates generally to a seat serial number plate, and more particularly, to a seat serial number plate suitable for fast assembly and disassembly.

### 2. The Prior Arts

In many event venues, conference halls, or outdoor performance venues with many participants, a common practice is to place rows of chairs for the participants to sit on. In order to facilitate participants to quickly find their own seat, the seats are generally provided with an identifiable serial number, such as a row number and a sequence number to for the participants to locate the seat conveniently. A seat serial number plate is such an identification item, often marked with numbers and/or English letters.

However, in general, seats labeled with row numbers and sequence numbers are mostly fixed seats, and are inconvenient to move. In contrast, portable chairs are often used when the number and the arrangement of the seats must be changed due to certain circumstances. However, the conventional portable chairs are not labeled with row number or sequence number, locating a seat becomes an inconvenient, time-consuming or even daunting task for the participants.

### SUMMARY OF THE INVENTION

A primary objective of the present invention is to provide a seat serial number plate, suitable for fast assembly and disassembly.

For achieving the foregoing objectives, the present invention provides a seat serial number plate, comprising a plate and a bracket. The plate has a first surface and a second surface, the first surface is for displaying a serial number; the bracket comprises at least a connecting portion, a supporting portion and a seat engaging portion, the at least a connecting portion is disposed on the second surface of the plate, the supporting portion is disposed on the at least a connecting portion, and the seat engaging portion is disposed on the supporting portion and is configured to be detachably disposed on an assembly portion of a seat.

In an embodiment of the present invention, the seat engaging portion comprises a hook portion and a positioning slot; the hook portion protrudes from the supporting portion for passing through a latch slot of the assembly portion of the seat, and is hooked to a bottom of the latch slot of the assembly portion of the seat; the positioning slot is disposed on the supporting portion and comprises a large hole and a small hole, and the large hole of the positioning slot is used for a bump of the assembly portion of the seat to pass through, the bump is further moved to the small hole of the positioning slot and is latched in the small hole of the positioning slot.

According to an embodiment of the present invention, the small hole of the positioning slot is located between the large hole of the positioning slot and the hook portion.

According to an embodiment of the present invention, the hook portion is located above the positioning slot.

According to an embodiment of the present invention, the hook portion and the positioning slot are arranged along the length direction of the supporting portion.

In an embodiment of the present invention, the seat engaging portion comprises at least a fixing rod, and the at least a fixing rod comprises a rod portion and a head portion. The rod portion protrudes from one side of the supporting portion, and the head portion is disposed on one end of the rod portion. The head portion has an outer dimension larger than outer diameter of the rod portion at least in one direction, and the head portion is used to pass through a large hole of a through slot of the assembly portion of the seat, and the rod portion enters the large hole of the through slot and further moves to a small hole of the through slot.

According to an embodiment of the present invention, two end surfaces of the head portion in longitudinal direction are respectively defined as a first end surface and a second end surface, two surfaces in width direction of the head portion are respectively defined as a top surface and a bottom surface, and two sides in thickness direction of the head portion are respectively defined as an outer side surface and an inner side surface, the inner side surface of the head portion is disposed at one end of the rod portion, the outer diameter of the head portion in the longitudinal direction is larger than the outer diameter of the rod portion, and the outer diameter of the head portion in the width direction is equal to the outer diameter of the rod portion.

In an embodiment of the present invention, the seat engaging portion comprises two fixing rods, and the bottom surface of the head portion of one of the two fixing rods is near the top surface of the head portion of the other fixing rod.

According to an embodiment of the present invention, the top surface and the bottom surface of each of the fixing rods are flat surfaces.

According to an embodiment of the present invention, a gap is disposed between the bottom surface of the head portion of one of the fixing rods and the top surface of the head portion of the other fixing rod.

According to an embodiment of the present invention, the first end surface and the second end surface of the head portion of each fixing rod are outwardly convex curved surfaces.

According to an embodiment of the present invention, the two fixing rods are arranged along the length direction of the supporting portion.

In an embodiment of the present invention, the plate is a round disk, an elliptical disk or a rectangular shape.

In an embodiment of the present invention, the bracket comprises two connecting portions connected between the two ends of the length direction of the supporting portion and the second surface of the plate.

In an embodiment of the present invention, the seat serial number plate further comprises a sticker, and the sticker is adhered to the first surface and has a printed layer.

The effect of the present invention is that the present invention can be conveniently and firmly assembled to the seat through the seat engaging portion to achieve fast assembly and disassembly.

Furthermore, the present invention allows the participants to quickly and conveniently locate the seat by looking at the printing on the printed layer on the plate or a sticker adhered to the printed layer.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view illustrating a seat serial number plate according to the first embodiment of the present invention;

FIG. 2 is a rear view of the seat serial number plate according to the first embodiment of the present invention;

FIG. 3 is a side view of the seat serial number plate according to the first embodiment of the present invention;

FIG. 4 is a schematic view of the seat serial number plate assembled to and disassembled from the seat according to the first embodiment of the present invention;

FIG. 5 is a perspective view illustrating a seat serial number plate according to the second embodiment of the present invention;

FIG. 6 is a rear view of the seat serial number plate according to the second embodiment of the present invention;

FIG. 7 is a schematic view of the seat serial number plate assembled to and disassembled from the seat according to the second embodiment of the present invention;

FIG. 8 is a schematic dissected view of the use of the seat serial number plate assembled to and disassembled from the seat according to the first and second embodiments of the present invention;

FIG. 9 is a schematic assembled view of the use of the seat serial number plate assembled to and disassembled from the seat according to the first and second embodiments of the present invention;

FIG. 10A is a perspective view illustrating a seat serial number plate according to the third embodiment of the present invention;

FIG. 10B is a perspective view illustrating a seat serial number plate according to the fourth embodiment of the present invention;

FIG. 11A is a perspective view illustrating a seat serial number plate according to the fifth embodiment of the present invention;

FIG. 11B is a dissected view illustrating a seat serial number plate according to the third embodiment of the present invention; and

FIG. 12 is a perspective view illustrating a seat serial number plate according to the sixth embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

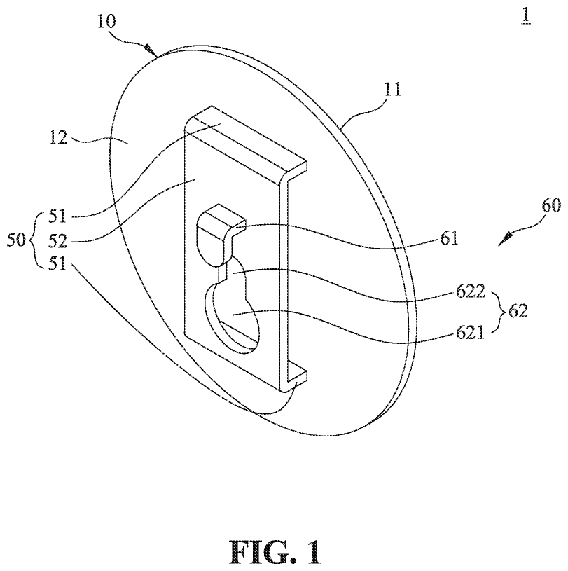

Referring to FIG. 1, FIG. 1 is a perspective view illustrating a seat serial number plate according to the first embodiment of the present invention. As shown in FIG. 1, the seat serial number plate of the present invention comprises a plate 10 and a bracket 30. The following describes the components in details.

The plate 10 has a first surface 11 and a second surface 12. The first surface 11 is for displaying a serial number. In the first embodiment of the present invention, the plate 10 has a shape of a round disk; however, the shape of the plate 10 is not limited to the above embodiment. The shape of the plate 10 can be changed according to requirement.

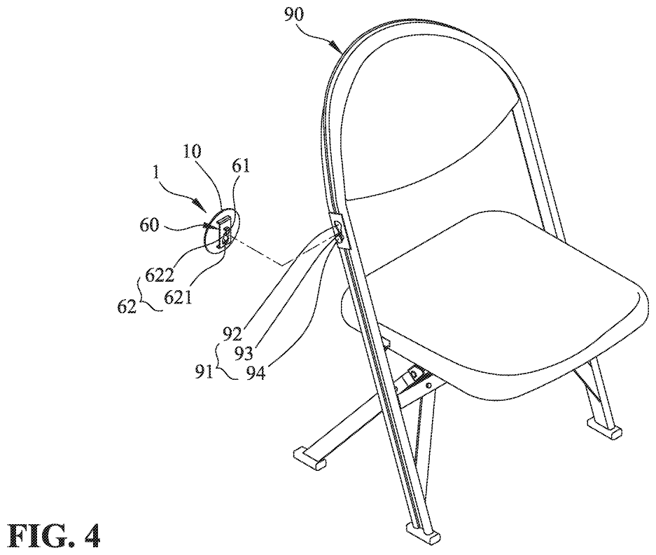

The bracket 20 comprises two connecting portions 51, a supporting portion 52 and a seat engaging portion 60. Each connecting portion 51 has two ends connected to the second surface 12 and the supporting portion 52 respectively. Specifically, one end of each connecting portion is connected to the second surface 12 of the plate 10 and the other end is connected to the supporting portion 52. The seat engaging portion 60 is disposed on the supporting portion 52 and is configured to be detachably disposed on an assembly portion of a seat 90 (as shown in FIG. 4).

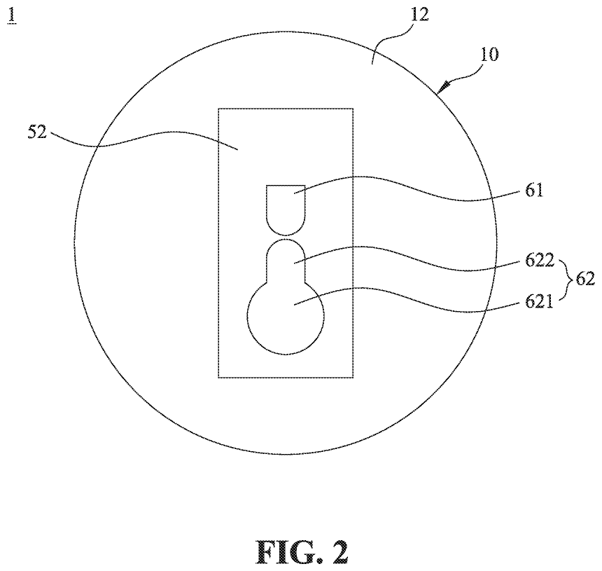

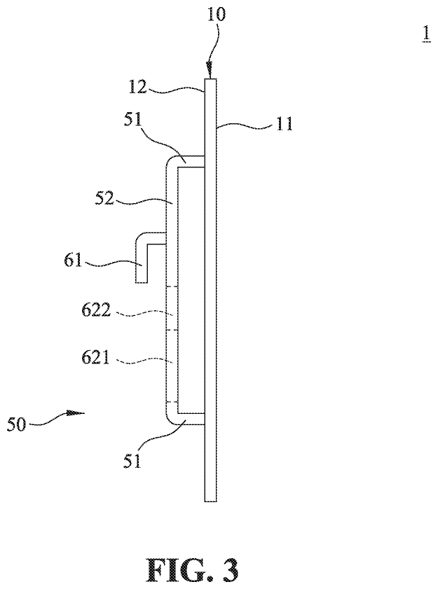

FIG. 2 and FIG. 3 are a rear view and a side view of the seat serial number plate of the first embodiment of the present invention respectively. As shown in FIG. 2 and FIG. 3, in the first embodiment of the present invention, the seat engaging portion 60 comprises a hook portion 61 and a positioning slot 62; the hook portion 61 protrudes from the supporting portion 52. The positioning slot 63 is disposed on the supporting portion 52, and comprises a large hole 621 and a small hole 622. Preferably, the hook portion 61 and the positioning slot 62 are arranged along the length direction of the supporting portion 52, and the hook portion 61 is located above the positioning slot 62. The small hole 622 of the positioning slot 62 is located between the large hole 621 of the positioning slot 62 and the hook portion 61.

FIG. 4 is a schematic view of the seat serial number plate assembled to and disassembled from the seat according to the first embodiment of the present invention. As shown in FIG. 4, in the first embodiment of the present invention, the seat 90 is disposed with a first assembly portion 91 at the right side. The first assembly portion 91 comprises a latch slot 92 and a bump 94. To assemble the seat serial number plate 1 of the present invention to the seat 90, the hook portion 61 is passed through the latch slot 92 of the first assembly portion 91, and is hooked to a bottom 93 of the latch slot 92. Also, the bump 94 of the first assembly portion 91 passes the large hole 621 of the positioning slot 62, and the bump 94 is further moved to the small hole 622 of the positioning slot 62 and is latched in the small hole 622 of the positioning slot 62. As such, the seat serial number plate 1 of the present invention is assembled to the seat 90.

To disassemble the seat serial number plate 1 of the present invention from the seat 90, the hook portion 61 is moved in the opposite direction to the bottom portion 93 of the latch slot 92, and the bump 94 is moved from the small hole 622 to the large hole 621, so that the seat serial number plate 1 of the present creation can be disassembled from the seat 90. Thereby, the seat serial number plate 1 of the present invention can achieve fast disassembly from the seat 90.

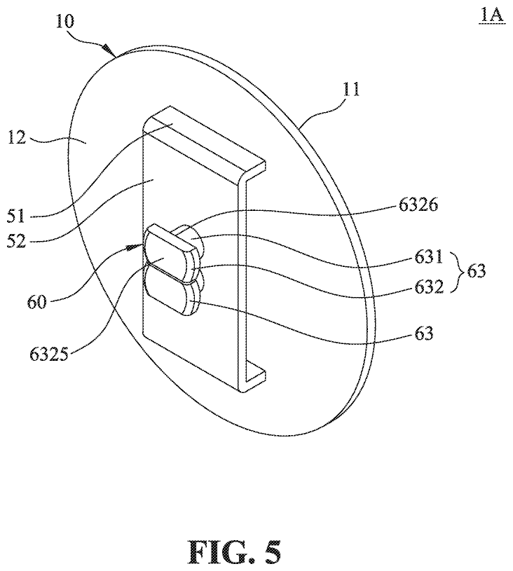

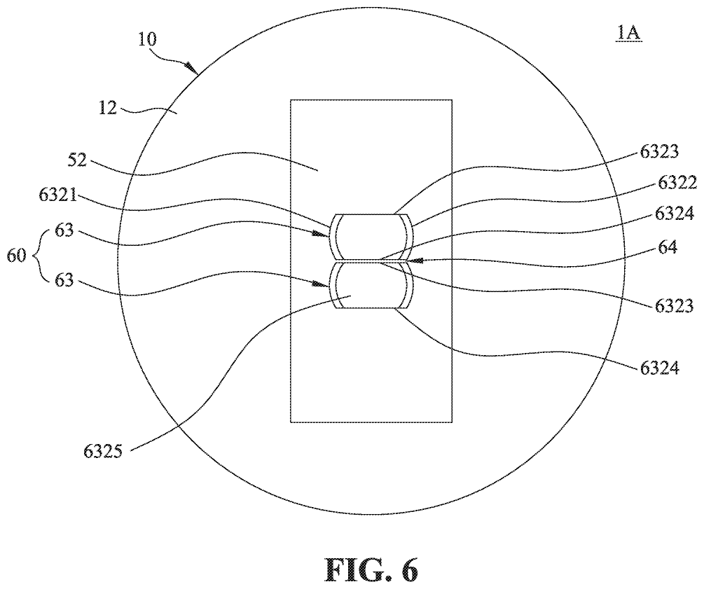

FIG. 5 and FIG. 6 show a perspective view and a side view respectively of the seat serial number plate 1A of the second embodiment of the present invention. As shown in FIG. 5 and FIG. 6, the second embodiment of the present invention differs from the first embodiment in that the seat engaging portion 60 comprises two fixing rods 63. Each fixing rod 63 comprises a rod portion 631 and a head portion 632. The rod portion 631 protrudes from one side of the supporting portion 52, and the head portion 632 is disposed on one end of the rod portion 631. The head portion 632 has an outer dimension larger than outer diameter of the rod portion 631 at least in one direction.

Specifically, for convenience of explanation, the following definitions are given to the sides of the head portion 632 of the fixing rod 63. Two end surfaces of the head portion 632 in longitudinal direction are respectively defined as a first end surface 6321 and a second end surface 6322, two surfaces in width direction of the head portion 632 are respectively defined as a top surface 6323 and a bottom surface 6324, and two sides in thickness direction of the head portion 632 are respectively defined as an outer side surface 6325 and an inner side surface 6326.

Accordingly, the inner side surface 6326 of the head portion 632 is disposed at one end of the rod portion 631, the outer diameter of the head portion 632 in the longitudinal direction is larger than the outer diameter of the rod portion 631, and the outer diameter of the head portion 632 in the width direction is equal to the outer diameter of the rod portion 631.

Preferably, in the second embodiment of the present invention, the two fixing rods 63 are arranged along the length direction of the supporting portion 52. The bottom surface 6324 of the head portion 632 of one of the two fixing rods 632 is near the top surface 6323 of the head portion 632 of the other fixing rod 63, and the top surface 6323 and the bottom surface 6324 of each of the fixing rods 63 are flat surfaces. The first end surface 6321 and the second end surface 6322 of the head portion 632 of each fixing rod 63 are outwardly convex curved surfaces. Preferably, a gap 64 is disposed between the bottom surface 6324 of the head portion 632 of one of the fixing rods 63 and the top surface 6323 of the head portion 632 of the other fixing rod 63.

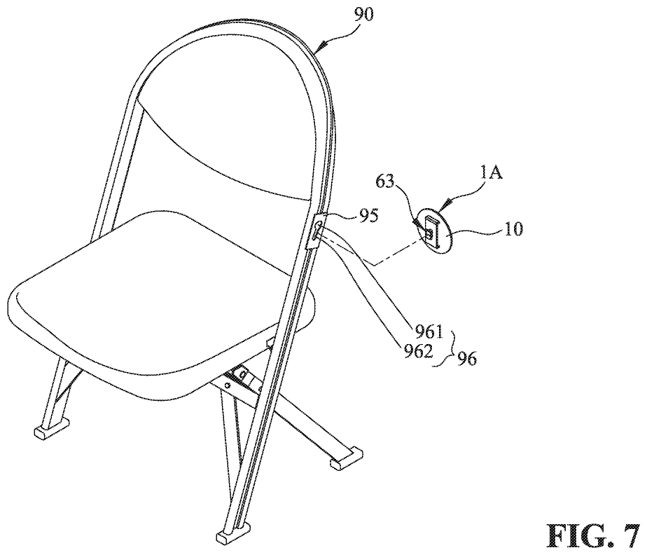

FIG. 7 is a schematic view of the seat serial number plate 1A assembled to and disassembled from the seat according to the second embodiment of the present invention. As shown in FIG. 7A, in the second embodiment of the present invention, the seat 90 has a second assembly portion 95 disposed on the left side. The second assembly portion 95 comprises a through slot 96, and the through slot 96 comprises a large hole 961 and a small hole 962.

To assemble the seat serial number plate 1A of the present invention to the seat 90, the head portions 632 of the two fixing rods 63 are first passed through the large hole 961 of the through slot 96 of the second assembly portions 95, and the rod portions 631 of the two fixing rod 63 enter the large hole 961 of the through slot 96 and are further moved to the small hole 962 of the through slot 96, so that the seat serial number plate 1A of the present invention can be fixed to the seat 90.

Preferably, the outer diameter of the head portion 632 of the two fixing rods 63 in the length direction is smaller than the large hole 961 of the through slot 96 of the second assembly portions 95, and is larger than that of the small hole 962 of the through slot 96 of the second assembly portion 95. The head portion 632 can pass through the large hole 961 and does not fall off when the rod portion 631 moves through the small hole 962.

To remove the seat serial number plate 1A of the present invention from the seat 90, the head portions 632 of the two fixing rods 63 are moved toward the small hole 962 of the through slot 96 in the opposite direction to the large hole 961. As such, the seat serial number plate 1A of the present invention can be removed from the seat 90. Thereby, the seat serial number plate 1A of the present invention can achieve the fast disassembly from the seat 90.

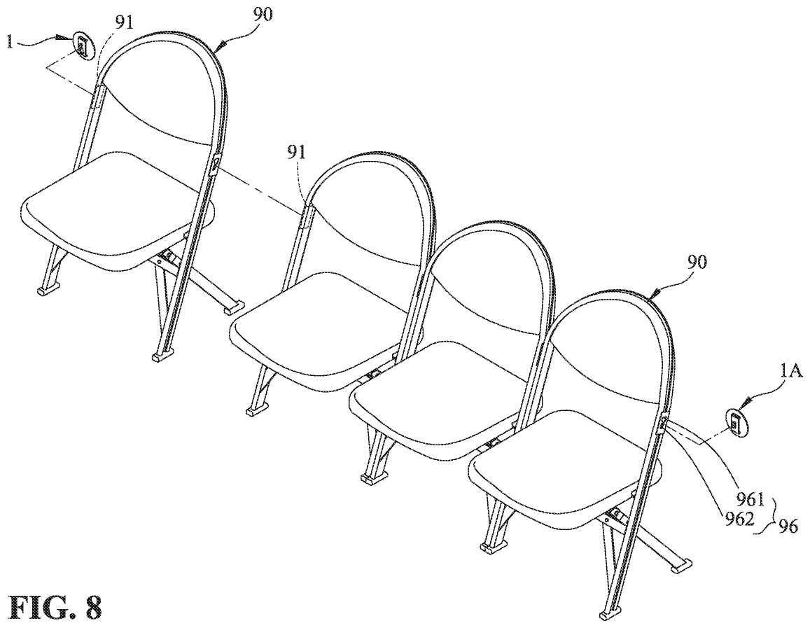

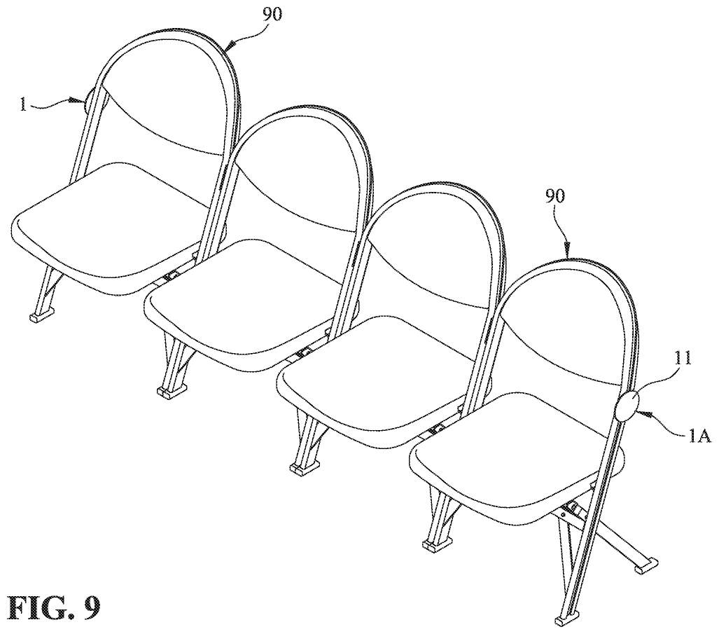

FIG. 8 and FIG. 9 show a schematic dissected view and a schematic assembled view respectively of the use of the seat serial number plate 1A assembled to and disassembled from the seat according to the first and second embodiments of the present invention. As shown in FIG. 8 and FIG. 9, a plurality of seats 90 are assembled through connecting the first assembly portion 91 and the second assembly portion 95 on two adjacent seats. Specifically, each seat 90 has a first assembly portion 91 on the right side and a second assembly portion 95 on the left side. By disposing the bump 94 of the first assembly portion 91 of a seat 90 in the through slot 96 of the second assembly portion 95 of another seat 90 so that the bump 94 passes through the large hole 961 of the through hole 96 and moves to the small hole 962, the two seats 90 are connected. In addition, the connection of the adjacent seats 90 in the plurality of seats 90 can be nicely aligned to avoid disarraying the seat arrangement.

Furthermore, to further facilitate locating the seats, the seat serial number plates 1, 1A can be placed on the two side seats 90 of each row. Specifically, the seat serial number plate 1 of the first embodiment of the present invention and the seat serial number plate 1A of the second embodiment are respectively disposed on the second assembly portion 95 on the left side of each row of seats 90 and the first assembly portion 91 on the right side of each row of seats 90. The participants can find their seats by the serial number displayed on the first surface 11 on the seat serial number plates 1, 1A.

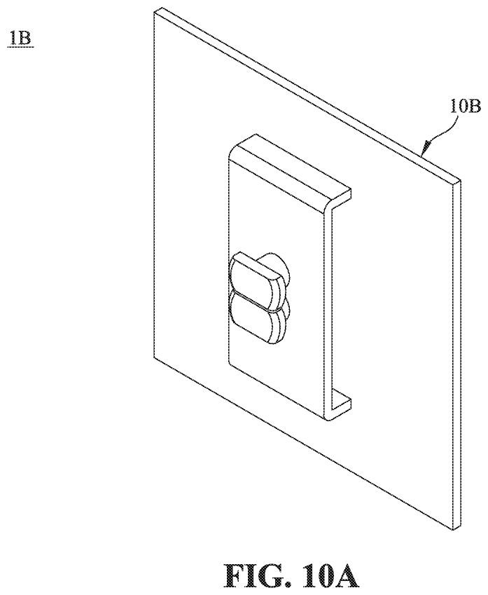

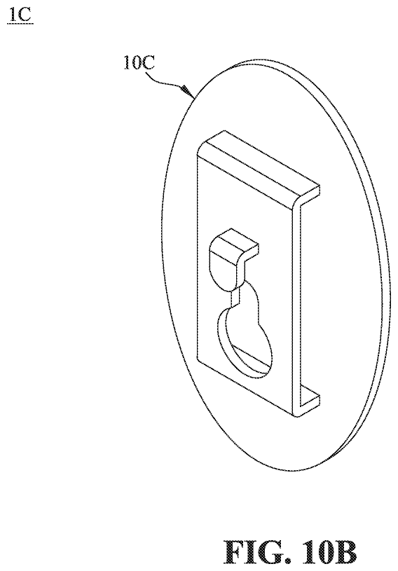

FIG. 10A is a perspective view illustrating a seat serial number plate 1B according to the third embodiment of the present invention. As shown in FIG. 10A, the third embodiment of the present invention differs from the second embodiment in that the plate 10B of the seat serial number plate 1B has a rectangular shape.

FIG. 10B is a perspective view illustrating a seat serial number plate 1C according to the fourth embodiment of the present invention. As shown in FIG. 10B, the fourth embodiment of the present invention differs from the first embodiment in that the plate 10C of the seat serial number plate 1C has a shape of ellipse disk. However, the shape of the plate is not limited thereto, and may also be a hexagonal disk shape or other shapes.

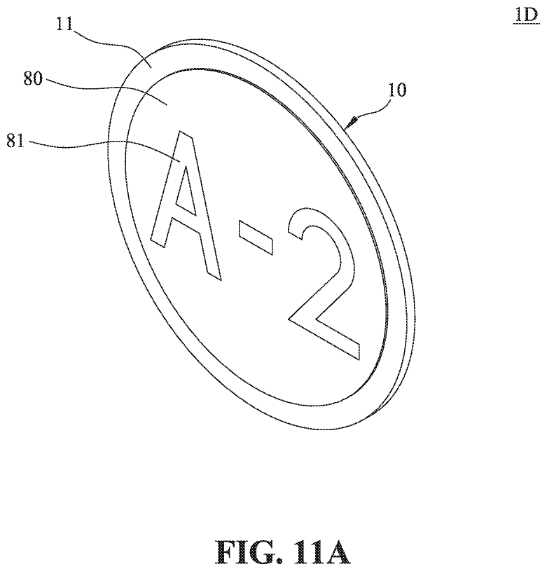

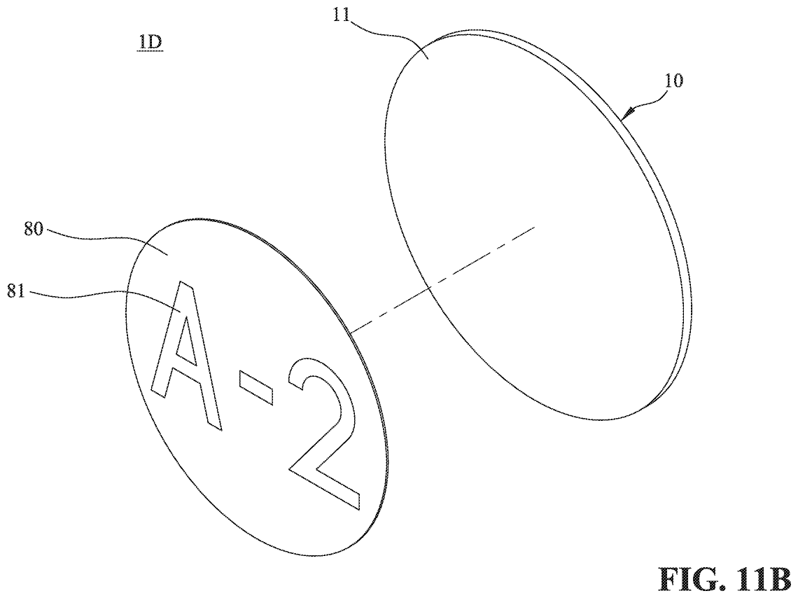

FIG. 11A and FIG. 11B show a perspective view and a dissected view respectively illustrating a seat serial number plate 1D according to the fifth embodiment of the present invention. As shown in FIG. 11A and FIG. 11B, in the fifth embodiment of the present invention, the seat serial number plate 1D further comprises a sticker 80. The sticker 80 is adhered to the first surface 11 and comprises a printed layer 81. Preferably, the printed layer 81 is printed with a serial number for easy recognition.

Thereto, the serial number of the fifth embodiment is a combination of numbers and/or English letters. However, the serial number is not limited thereto, and other identifiable marks can be used.

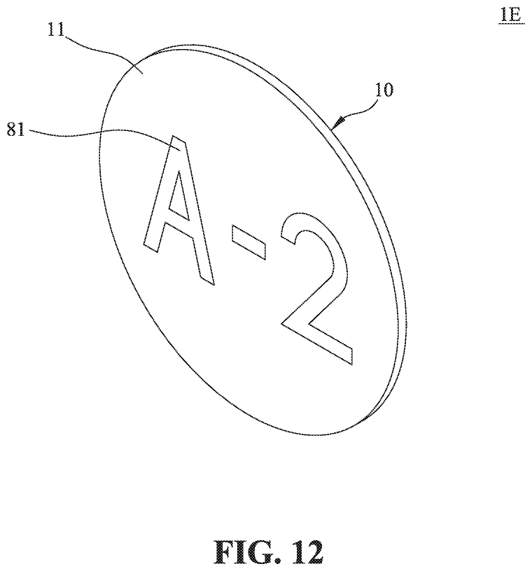

FIG. 12 is a perspective view illustrating a seat serial number plate 1E according to the sixth embodiment of the present invention. As shown in FIG. 12, the sixth embodiment of the present invention differs from the fifth embodiment in that the printed layer 81 of the seat serial number plate 1E is directly printed on the first surface 11 of the plate 10 for displaying a serial number.

The seat serial number plate of the present invention can be conveniently and firmly assembled to the seat 90 by the seat engaging portion 60, thereby achieving fast assembly and disassembly.

Furthermore, the seat serial number plate of the present invention enable the participants to locate their seats conveniently through a printed layer 81 or a sticker 80 with a printed layer 81 adhered to the plate 10.

Although the present invention has been described with reference to the preferred embodiments thereof, it is apparent to those skilled in the art that a variety of modifications and changes may be made without departing from the scope of the present invention which is intended to be defined by the appended claims.

1. A seat serial number plate, comprising:
a plate, having a first surface and a second surface, the first surface being for displaying a serial number; and
a bracket, comprising at least a connecting portion, a supporting portion and a seat engaging portion, the at least a connecting portion being disposed on the second surface of the plate, the supporting portion being disposed on the at least a connecting portion, and the seat engaging portion being disposed on the supporting portion and configured to be detachably disposed on an assembly portion of a seat.

2. The seat serial number plate according to claim 1, wherein the seat engaging portion comprises a hook portion and a positioning slot; the hook portion protrudes from the supporting portion for passing through a latch slot of the assembly portion of the seat, and is hooked to a bottom of the latch slot of the assembly portion of the seat; the positioning slot is disposed on the supporting portion and comprises a large hole and a small hole, and the large hole of the positioning slot is used for a bump of the assembly portion of the seat to pass through, and the bump is further moved to the small hole of the positioning slot and is latched in the small hole of the positioning slot.

3. The seat serial number plate according to claim 2, wherein the small hole of the positioning slot is located between the large hole of the positioning slot and the hook portion.

4. The seat serial number plate according to claim 3, wherein the hook portion is located above the positioning slot.

5. The seat serial number plate according to claim 2, wherein the hook portion and the positioning slot are arranged along the length direction of the supporting portion.

6. The seat serial number plate according to claim 1, wherein the seat engaging portion comprises at least a fixing rod, and the at least a fixing rod comprises a rod portion and a head portion; the rod portion protrudes from one side of the supporting portion, and the head portion is disposed on one end of the rod portion;
the head portion has an outer dimension larger than outer diameter of the rod portion at least in one direction, and the head portion is used to pass through a large hole of a through slot of the assembly portion of the seat, and the rod portion enters the large hole of the through slot and further moves to a small hole of the through slot.

7. The seat serial number plate according to claim 6, wherein two end surfaces of the head portion in longitudinal direction are respectively defined as a first end surface and a second end surface, two surfaces in width direction of the head portion are respectively defined as a top surface and a bottom surface, and two sides in thickness direction of the head portion are respectively defined as an outer side surface and an inner side surface, the inner side surface of the head portion is disposed at one end of the rod portion, the outer diameter of the head portion in the longitudinal direction is larger than the outer diameter of the rod portion, and the outer diameter of the head portion in the width direction is equal to the outer diameter of the rod portion.

8. The seat serial number plate according to claim 7, wherein the seat engaging portion comprises two fixing rods, and the bottom surface of the head portion of one of the two fixing rods is near the top surface of the head portion of the other fixing rod.

9. The seat serial number plate according to claim 8, wherein the top surface and the bottom surface of each of the fixing rods are flat surfaces.

10. The seat serial number plate according to claim 9, wherein a gap is disposed between the bottom surface of the head portion of one of the fixing rods and the top surface of the head portion of the other fixing rod.

11. The seat serial number plate according to claim 9, wherein the first end surface and the second end surface of the head portion of each fixing rod are outwardly convex curved surfaces.

12. The seat serial number plate according to claim 7, wherein the two fixing rods are arranged along the length direction of the supporting portion.

13. The seat serial number plate according to claim 1, wherein the plate has a shape of a round disk, an elliptical disk or a rectangular shape.

14. The seat serial number plate according to claim 1, wherein the bracket comprises two connecting portions connected between the two ends of the length direction of the supporting portion and the second surface of the plate.

15. The seat serial number plate according to claim 1, wherein the seat serial number plate further comprises a sticker, and the sticker is adhered to the first surface and has a printed layer.
